(19) United States
(12) Patent Application Publication
(10) Pub. No.: US 2010/0205626 A1
(43) Pub. Date: Aug. 12, 2010

(54) SYSTEM AND METHOD FOR IDENTIFYING AND DOWNLOADING BROADCAST PROGRAMMING CONTENT

(76) Inventors: Steven M. Miller, Cary, NC (US); Mark E. Peters, Chapel Hill, NC (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/368,644

(22) Filed: Feb. 10, 2009

(51) Int. Cl. H04N 7/16; H04H 60/33

(52) U.S. Cl. 725/9; 455/2.01

(57) ABSTRACT

The present invention is directed to a system, method and program product for identifying and downloading broadcast programming. Systems are disclosed that include a media device structured to receive and sample broadcast programming, and an identification service including an electronic library. The media device may include a receiver operable to receive the broadcast programming and media device information; a memory operable to save the received broadcast programming and media device information; a sampling device operable to replay and sample the received broadcast programming; and a transmitter operable to transmit the sampled broadcast programming and the media device information. The identification service may be structured to receive the sampled broadcast programming and the media device information, compare the sampled broadcast programming and the media device information with library information stored in the electronic library, and retrieve at least one of a matching broadcast programming and identification information about the broadcast programming.

### FIELD OF THE INVENTION

The present invention relates to identifying and downloading broadcast programming content. More specifically, the present invention relates to a system, method and program product for identifying and downloading broadcast programming content based on user information and sampling of the broadcast programming.

### BACKGROUND OF THE INVENTION

When listening to or watching broadcast programming, it may be desirable for a listener or viewer to identify the particular content at that time, and obtain a copy of the content. Often, a listener or viewer may not be “tuned in” at the beginning of a broadcast program, television or radio interview, song, etc., which makes identifying the content more complicated. Further, the ability to record the content is difficult if not planned for or known about ahead of time.

Digital technology allows for the identification and purchasing of desired content of broadcast programming. Further, cell phones and other portable devices exist that are capable of downloading and recording desired content. However, these means generally fall short of providing a way to easily identify and secure desired content, particularly for local broadcast material, as this information may not be generally available and known in databases of related art services for identification.

### SUMMARY OF THE INVENTION

A first aspect of the present invention is directed to a system for identifying broadcast programming. In an illustrative embodiment, the system may comprise a media device structured to receive and sample broadcast programming, and an identification device. The media device may include a receiver operable to receive the broadcast programming and media device information, a memory operable to save the received broadcast programming and media device information, a sampling device operable to replay and sample the received broadcast programming and a transmitter operable to transmit the sampled broadcast programming and the media device information.

A second aspect of the invention is directed to another system for identifying broadcast programming. In an illustrative embodiment, the system may comprise a processor, an electronic library, and a memory including an identification service stored on the memory. The identification service may include a data capture system structured to receive a sampled broadcast programming and media device information; a compare system structured to compare the sampled broadcast programming and the media device information with library information stored in the electronic library, and retrieve at least one of a matching broadcast programming and identification information about the broadcast programming; and a notification system structured to transmit the at least one of the matching broadcast programming and the identification information.

A third aspect of the present invention is directed to a method for receiving and sampling broadcast programming with a media device. The method may include receiving a sampled broadcast programming and information regarding a media device, comparing the sampled broadcast programming and the media device information with library information stored in an electronic library, retrieving at least one of a matching broadcast programming and identification information about the broadcast programming from the electronic library, and transmitting the at least one of the matching broadcast programming and the identification information to the media device.

A fourth aspect of the present invention is directed to a computer readable medium having a program product stored thereon for identifying broadcast programming. The program product may comprise program code for receiving and sampling broadcast programming with a media device; program code for transmitting the sampled broadcast programming and media device information; and program code for receiving at least one of a matching broadcast programming and identification information about the broadcast programming.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a system in accordance with an illustrative embodiment of the present invention;

FIG. 2 depicts a media device in accordance with another illustrative embodiment of the present invention; and

FIG. 3 depicts a flowchart of a method in accordance with an illustrative embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

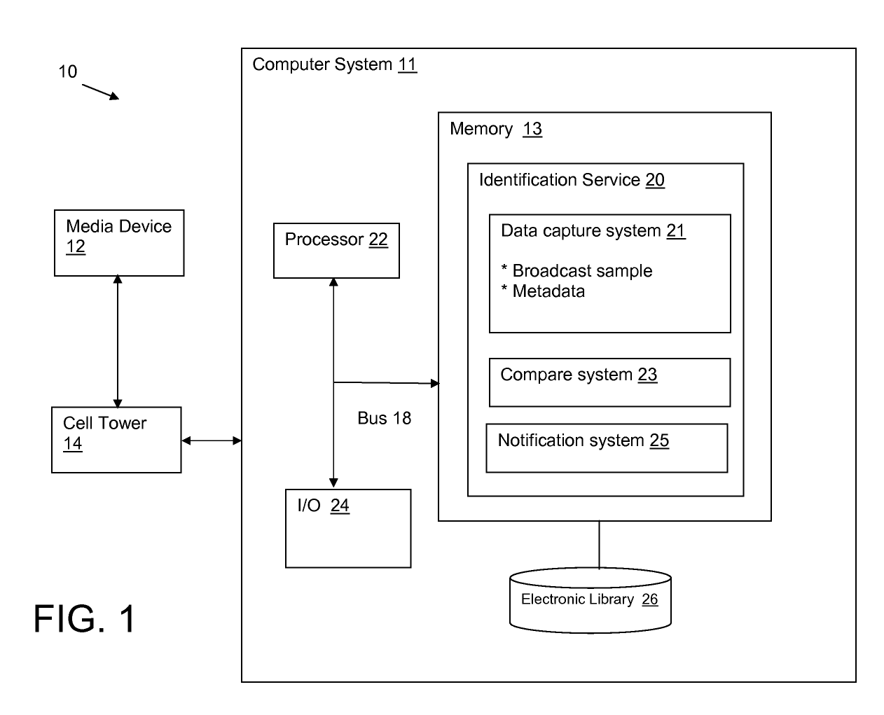

FIG. 1 shows an illustrative embodiment of a system 10 according to the present invention. The illustrative system 10 includes a media device 12; a cellular tower 14; a computer system 11 having an identification service 20 stored in memory 13.

The media device 12 may include any electronic device capable of receiving and sending signals, such as a Personal Digital Assistant (PDA), a cellular phone, a handheld computer, a Voice over Internet Protocol (VoIP) station, a desktop computer, a laptop computer, etc.

The cellular tower 14, as known in the art, may be a site where antennas and electronic communications equipment are placed to create a cell in a cellular network (not shown). The cellular network may be used to facilitate communication between the media device 12 and the identification service 20.

Computer system 11 may include a processor 22, an input/output (I/O) 24, a memory 13 for storing identification service 20 (e.g., as a program product that can be executed by processor 22) and an electronic library 26.

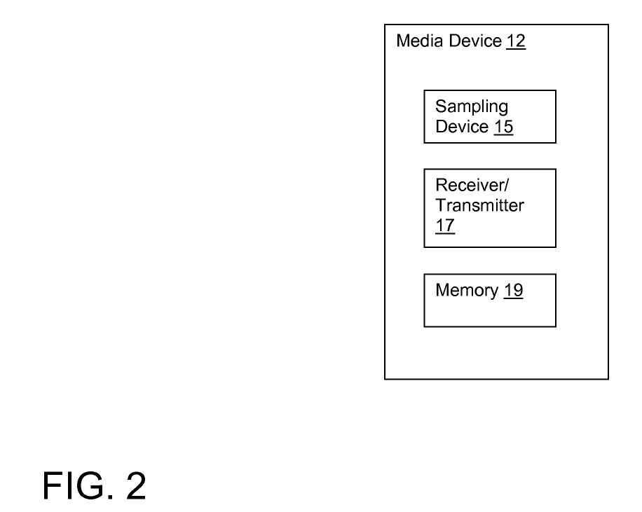

As shown in detail in FIG. 2, the media device 12 may include a sampling device 15, a receiver/transmitter 17, and a memory 19. The receiver/transmitter 17 may have USB (Universal Serial Bus) capability for syncing with iTunes®, Rhapsody®, or some other application where the application is capable of querying the stored broadcast information.

The media device 12, such as a cell phone, may be used to initiate the identification of broadcast programming. The broadcast programming may include all media, and in an illustrative embodiment, include music, television, and other programming. As an example, if a user was listening to a National Public Radio (NPR) station and only caught the middle of an interview with an author, the user may be interested in knowing who the author is and what book is being discussed. Depending on the broadcast, the user may not even catch the name of the author or the book title, just part of an interesting discussion.

In the present invention, instead of, for example, going home and combing through a website to try to obtain information about the NPR broadcast, the user may call into the identification service 20, place their phone (media device 12) to a radio, and obtain the information on that part of the broadcast via transmission to the user in an email, text message, etc. The user may, for example, obtain the name of the program, the host, the author interviewed, the main topics of their interview, and a link to where the program can be purchased or viewed at a later time.

Referring to FIG. 2 again, to obtain information about a broadcast, a user may initiate the sampling device 15 of the media device 12 to record and/or sample a portion of the broadcast. The recorded and/or sampled portion of the broadcast may be stored in memory 19.

Also stored in memory 19 may be information about the user and/or the media device 12. The information may include a location of the media device 12 at the time of the broadcast, known access to programming sources (e.g., satellite services, cable, and other subscription services), the time-of-day and date, and other personal profile data. The location of the media device 12 at the time of the broadcast may be determined via Global Positioning System (GPS) capabilities of the media device 12 that determine the coordinates of the media device 12 at the time of the broadcast, for example.

The user may then transmit the recorded and/or sampled portion of the broadcast via transmitter 17 of media device 12 to the identification service 20 (FIG. 1). The transmission of the recorded and/or sampled portion of the broadcast may include transmission in the cellular network (not shown) using cellular tower 14, however, the invention is not limited to cellular communication and may include other communication media known in the art, including both wireless and wired communication.

Along with the transmission of the recorded and/or sampled portion of the broadcast to the identification service 20, the user may include the information about the user and/or the media device 12. By using available information about the user and the media device 12, a more intelligent search can occur than with other “blind” search services.

Further, other metadata associated with the user and the capture of the sampled portion of the broadcast may be transmitted to aid in the proper identification of the broadcast. This may include a location of cellular tower 14 and other information identifying the area of use of the media device 12. The metadata need not be provided by the media device 12 itself, but could be obtained by the identification service 20 by other data collection means known in the art (e.g., a third party database that stored user preferences or demographics).

The identification service 20 may receive the recorded and/or sampled portion of the broadcast along with the information about the user and/or the media device 12 at input/output (I/O) 24, which is input into identification service 20 via data capture system 21. Also, the other metadata associated with the user and the capture of the sampled portion of the broadcast may be received.

A compare system 23 may then compare the sampled portion of the broadcast and the media device 12 information with library information stored in the electronic library 26, and retrieve matching broadcast programming and/or identification information about the broadcast programming. Compare system 23 may also be operable to filter out background noise or other noise not associated with the sample portion.

Compare system 23 may further be operable to queue up the matching broadcast at a point in the broadcast identified by the sampled portion.

Notification system 25 may then transmit the matching broadcast and/or the identification information of the broadcast to the media device 12. Or, the notification system 25 may provide notification of the availability of the broadcast and the identification information. Notification may be transmitted immediately or deferred through email, voice message, short message service (SMS), instant messenger (IM) or other messaging service. The notification may also include the means by which to obtain the matching broadcast and the identification information of the broadcast, e.g., a link to a media purchasing service.

In another illustrative embodiment of the present invention, understanding that some broadcast programming may be currently in progress, for example, broadcast programming such as “podcasts” and other recorded forms that may not be available in real-time but will be at a later time, the transmission and delivery of the identification information may be deferred for a reasonable time to allow for materials to be made available by the broadcast source. Many local broadcast stations, radio stations, television stations, etc., provide podcast materials on station websites for their audiences. By using the present invention, a search of these podcast materials and websites can factor in the information about the user and/or the media device 12 to better match media samplings than previously available.

In another illustrative embodiment of the present invention, a user of the media device 12 may query a vehicle radio to determine information about a broadcast using, for example, Bluetooth integration. The results returned to the user could include a title of the song being broadcast on the vehicle radio, artists or names of participants of a discussion, programming source information, station identification, etc.

In yet another illustrative embodiment of the invention, a podcast, MP3 or other recorded form of a broadcast could be provided, either as a free service or with payment taken as part of the service. Delivery of the broadcast material could take place by immediate download, deferred download, or other such means. Of course, the identification information about the broadcast could be available using similar protocols.

In another illustrative embodiment, the system could provide a user of media device 12 with choices as to whether only portions of a broadcast rather than the entire broadcast might be transmitted and/or purchased at a reduced price.

The present invention may include as part of the system, existing phones that include voice recording features and time and date stamps regarding recordings stored on the phone. In an illustrative embodiment, the phone may record an audio broadcast for the purpose of identification of the broadcast, and transfer the recorded broadcast via synchronization when the phone is proximate a user's computer. Alternately, the phone may sync using other no-charge broadband networks, such as a free public wireless area.

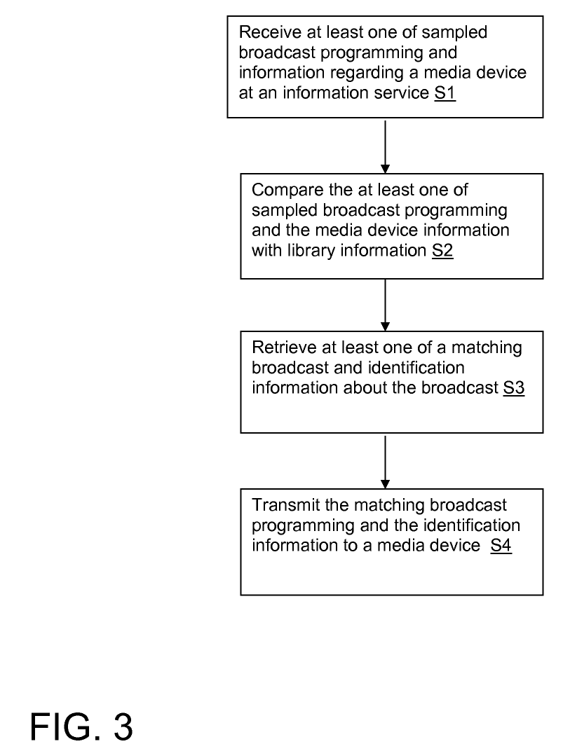

FIG. 3 depicts a flowchart of a method in accordance with an illustrative embodiment of the present invention. In S1, at least one of sampled broadcast programming and information regarding a media device may be received by an information service. In S2, the information service may compare the at least one of sampled broadcast programming and the media device information with library information stored in an electronic library.

In S3, the information service may retrieve at least one of a matching broadcast programming and identification information about the broadcast programming from the electronic library. In S4, at least one of the matching broadcast programming and the identification information may be transmitted to the media device.

Referring again to FIG. 1, it is understood that computer system 11 may be implemented as any type of computing infrastructure. Computer system 11 generally includes a processor 22, input/output (I/O) 24, memory 13, and bus 18. The processor 22 may comprise a single processing unit, or be distributed across one or more processing units in one or more locations, e.g., on a client and server. Memory 13 may comprise any known type of data storage including magnetic media, optical media, random access memory (RAM), read-only memory (ROM), a data cache, a data object, etc. Moreover, memory 13 may reside at a single physical location, comprising one or more types of data storage, or be distributed across a plurality of physical systems in various forms.

I/O 24 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 18 provides a communication link between each of the components in the computer system 11 and likewise may comprise any known type of transmission link, including electrical, optical, wireless, etc. Although not shown, additional components, such as cache memory, communication systems, system software, etc., may be incorporated into computer system 11.

Access to computer system 11 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 11 comprising an identification service 20 could be created, maintained and/or deployed by a service provider that offers the functions described herein for customers. That is, a service provider could offer to capture, compare, and notify regarding broadcast content as described above.

It is understood that in addition to being implemented as a system and method, the features may be provided as a program product stored on a computer-readable medium, which when executed, enables computer system 11 to provide an identification service 20. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 13 and/or a storage system.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

The foregoing description of the illustrative embodiments of this invention has been presented for purposes of illustration and description. It is not intended to be exhaustive or to limit the invention to the precise form disclosed, and clearly, many modifications and variations are possible.

What is claimed is:

1. A system for identifying broadcast programming, the system comprising:
a media device structured to receive and sample broadcast programming, the media device including:
a receiver operable to receive the broadcast programming and media device information;
a memory operable to save the received broadcast programming and media device information;
a sampling device operable to replay and sample the received broadcast programming; and
a transmitter operable to transmit the sampled broadcast programming and the media device information.

2. The system as claimed in claim 1, wherein the media device information comprises at least one of location of the media device, known access to programming sources for the media device, time of day, and user profile data.

3. The system as claimed in claim 2, wherein the media device information further comprises a cell tower location and area information associated with the location of the media device.

4. The system as claimed in claim 1, wherein the media device is selected from the group consisting of a Personal Digital Assistant (PDA), cellular phone, handheld computer, VOIP station, desktop computer, and laptop computer.

5. The system as claimed in claim 1, wherein the media device further comprises a Bluetooth integration device, the Bluetooth integration device operable to query a radio about transmitted broadcast programming.

6. A system for identifying broadcast programming, the system comprising:
a processor;
an electronic library; and
a memory including an identification service stored on the memory, the identification service when executed by the processor including:
a data capture system structured to receive a sampled broadcast programming and media device information;
a compare system structured to compare the sampled broadcast programming and the media device information with library information stored in the electronic library, and retrieve at least one of a matching broadcast programming and identification information about the broadcast programming; and
a notification system structured to transmit the at least one of the matching broadcast programming and the identification information.

7. The system as claimed in claim 6, wherein the identification information comprises at least one of title, artist, station identification, and a programming source of the broadcast programming.

8. The system as claimed in claim 7, wherein the programming source comprises at least one of a satellite service, a cable service, and a subscription service.

9. The system as claimed in claim 6, wherein the identification service is further structured to compare the sampled broadcast programming and the media device information with recorded actual broadcast programming.

10. The system as claimed in claim 6, wherein the identification service is operable to transmit the at least one of the matching broadcast programming and the identification information to a media device on a delay basis.

11. A method for identifying broadcast programming, the method comprising:
receiving sampled broadcast programming and media device information from a media device;
comparing the sampled broadcast programming and the media device information with library information stored in an electronic library;
retrieving at least one of a matching broadcast programming and identification information about the broadcast programming from the electronic library; and
transmitting the at least one of the matching broadcast programming and the identification information to the media device.

12. The method as claimed in claim 11, further comprising comparing the sampled broadcast programming and the media device information with recorded actual broadcast programming.

13. The method as claimed in claim 11, further comprising transmitting the at least one of the matching broadcast programming and the identification information to the media device on a delay basis.

14. The method as claimed in claim 11, wherein the media device information comprises at least one of location of the media device, known access to programming sources for the media device, time of day, and user profile data.

15. The method as claimed in claim 14, wherein the media device information further comprises information associated with the location of the media device.

16. The method as claimed in claim 11, wherein the identification information comprises at least one of title, artist, station identification, a programming source of the broadcast programming, and a link to obtain the broadcast programming.

17. The method as claimed in claim 16, wherein the programming source comprises at least one of a satellite service, a cable service, and a subscription service.

18. A computer readable medium having a program product stored thereon for identifying broadcast programming, the program product comprising:
program code for receiving sampled broadcast programming and media device information;
program code for comparing the sampled broadcast programming and the media device information with library information stored in an electronic library;
program code for retrieving at least one of a matching broadcast programming and identification information about the sampled broadcast programming; and
program code for transmitting at least one of the matching broadcast programming and the identification information.

19. The program product as claimed in claim 18, wherein the media device information comprises at least one of location of a media device, known access to programming sources for the media device, time of day, and user profile data.

20. The program product as claimed in claim 18, further comprising program code for comparing the sampled broadcast programming and the media device information with real-time broadcast programming.
